(19) United States
(12) Patent Application Publication
(10) Pub. No.: US 2020/0302494 A1
(43) Pub. Date: Sep. 24, 2020

(54) INFORMATION PROCESSING DEVICE, INFORMATION PROCESSING METHOD, PROGRAM, AND STORAGE MEDIUM

(71) Applicant: Rakuten, Inc., Tokyo (JP)

(72) Inventors: Anirudh BANARJI, Tokyo (JP); Teoh Chi YEONG, Tokyo (JP); Fumikazu FUJIWARA, Tokyo (JP); Hisashi INOUE, Tokyo (JP)

(73) Assignee: Rakuten, Inc., Tokyo (JP)

(21) Appl. No.: 15/779,585

(22) PCT Filed: Dec. 3, 2015
(86) PCT No.: PCT/JP2015/084036

§ 371 Date: May 29, 2018

(51) Int. Cl. G06Q 30/02; G06Q 30/06; G06F 40/279; G06F 40/10; G06F 16/332; G06F 16/9535

(52) U.S. Cl. CPC G06Q 30/0282; G06Q 30/0631; G06F 16/9535; G06F 40/10; G06F 16/3322; G06F 40/279

(57) ABSTRACT

An information processing apparatus includes at least one processor and at least one memory device that stores instructions for a computer, which when executed by the processor, cause the processor to extract keywords corresponding to a merchandise category from information managed per merchandise category in an electronic commerce site; select a keyword to present in an evaluation posting page for posting an evaluation for a merchandise belonging to the merchandise category from the keywords as an evaluation word; and present the evaluation word in the evaluation posting page. The evaluation word is presented as an individual evaluation item name of an individual evaluation column for a user evaluating the merchandise to input an evaluation value per an individual evaluation item set per merchandise or per merchandise category.

### TECHNICAL FIELD

The present invention relates to an information processing apparatus, an information processing method, a program, and a storage medium, and specifically relates to a technique to present an evaluation posting page for a merchandise.

### CITATION LIST

### Patent Literature

Patent Literature 1: Japanese Unexamined Patent Application Publication No. 2014-21578

### BACKGROUND ART

In shopping using an electronic commerce where a merchandise cannot be actually picked up at the time of purchase, a user evaluation given to the merchandise can be important information that determines sales numbers of the merchandise.

In view of such a situation, in order to increase the number of evaluations (reviews) for the merchandise, measures are sometimes taken, such as paying an incentive to a user who has posted an evaluation.

Patent Literature 1 discloses a system that ensures a post and a browse of review information.

### SUMMARY OF INVENTION

### Technical Problem

A review for merchandise is often posted by a user who has purchased the merchandise. However, many of the users are unfamiliar with the review and do not know what they should evaluate. Accordingly, the users possibly post similar merchandise reviews irrespective of a merchandise category.

Therefore, in consideration of such a situation, an object of the present invention is to provide an environment where an evaluation corresponding to a merchandise category is posted.

### Solutions to the Problems

An information processing apparatus according to the present invention includes a keyword extraction unit that extracts keywords corresponding to a merchandise category from information managed per merchandise category in an electronic commerce site, an evaluation word selection unit that selects a keyword to present in an evaluation posting page for posting an evaluation for a merchandise belonging to the merchandise category from the keywords as an evaluation word, and an evaluation word presentation unit that presents the evaluation word in the evaluation posting page.

This presents the evaluation word using the keyword corresponding to the merchandise category.

The evaluation word presentation unit in the above-described information processing apparatus presents the evaluation word as an evaluation item name.

This presents evaluation items including an evaluation item associated with the keyword to the user

The evaluation word presentation unit in the above-described information processing apparatus presents the evaluation word as a suggested word to assist an input of a review text.

This presents the keyword corresponding to the merchandise category when the review text is input.

The keyword extraction unit in the above-described information processing apparatus extracts the keyword from a merchandise page where merchandise information is included.

The information that the user wants to know is likely to be included in the merchandise page. At the time of the merchandise review, the evaluation word based on the information that the user wants to know is presented.

The keyword extraction unit in the above-described information processing apparatus extracts a character string highlighted in the merchandise page as the keyword.

An important keyword that a merchandise vendor who sells the merchandise wants to mainly assert is often highlighted. Such a keyword is presented as the evaluation word to the user.

The keyword extraction unit in the above-described information processing apparatus extracts the keyword from review texts posted by users per merchandise category.

The review text is likely to include information that a user who is considering a purchase of another merchandise belonging to an identical merchandise category also wants to know. Thus, the keyword extracted from the information that the user who is considering the purchase of the merchandise in the identical merchandise category wants to know is presented as the evaluation word to the user. The review made based on these evaluation words can be an evaluation index that the user wants to know.

The keyword extraction unit in the above-described information processing apparatus extracts the keyword from a review text whose content is determined to be appropriate among the review texts.

The appropriate review is likely to include an appropriate keyword. That is, the appropriate keyword is likely to be presented to the user.

The evaluation word selection unit in the above-described information processing apparatus selects the evaluation word from the keywords, considering a latest count of browses per unit time of a web page from which the keywords are acquired.

This facilitates a presentation of a keyword reflecting a trend corresponding to the merchandise category to the user.

The evaluation word selection unit in the above-described information processing apparatus, when the evaluation word selection unit additionally selects the evaluation word from the keywords, in a case where a count of the keyword already selected as the evaluation word has reached a predetermined number, replaces the current evaluation word with the keyword additionally selected as the evaluation word to keep a count of the evaluation word at the predetermined number or less.

That is, the number of the evaluation words becomes the predetermined number or less, thus keeping the number of the evaluation items at the predetermined number or less.

An information processing method according to the present invention causes an information processing apparatus to execute a keyword extracting step of extracting keywords corresponding to a merchandise category from information managed per merchandise category in a virtual mall site, an evaluation word selecting step of selecting a keyword to present in an evaluation posting page for a merchandise belonging to the merchandise category from the keywords as an evaluation word, and an evaluation word presenting step of presenting the evaluation word in the evaluation posting page.

This information processing method executes a process to provide the environment where the evaluation corresponding to the merchandise category is posted.

A program according to the present invention is a program to cause a processor to execute a process executed as the above-described information processing method.

A storage medium according to the present invention is a storage medium that stores the above-described program. These program and storage medium ensure the above-described information processing apparatus.

### Effects of the Invention

The present invention can provide the environment where the evaluation corresponding to the merchandise category is posted.

### BRIEF DESCRIPTION OF DRAWINGS

FIG. 1 is a view illustrating an overall configuration of an embodiment of the present invention.

FIG. 2 is a block diagram of an EC server of the embodiment.

FIG. 3 is a block diagram of a computer of the embodiment.

FIG. 4 is a view illustrating an exemplary review DB of the embodiment.

FIG. 5 is a view illustrating an exemplary evaluation posting page.

FIG. 6 is a view illustrating a state where a review content in a merchandise page is displayed on a web browser.

FIG. 7 is an explanation drawing of an exemplary overall process flow.

FIG. 8 is a flowchart illustrating an exemplary batch process.

FIG. 9 is a flowchart illustrating a first example of a keyword extraction process.

FIG. 10 is a flowchart illustrating a second example of the keyword extraction process.

FIG. 11 is a flowchart illustrating a third example of the keyword extraction process.

FIG. 12 is a flowchart illustrating a fourth example of the keyword extraction process.

FIG. 13 is a flowchart illustrating a fifth example of the keyword extraction process.

FIG. 14 is a flowchart illustrating a first example of an evaluation word selection process.

FIG. 15 is a flowchart illustrating a second example of the evaluation word selection process.

FIG. 16 is a view illustrating a second example of an evaluation word presentation process.

### DESCRIPTION OF PREFERRED EMBODIMENTS

In the embodiment, a description will be given of an EC (Electronic Commerce) server that provides an electronic commerce service as an example.

The following describes the embodiment in an order listed below.

<1. Overall Configuration>

<2. Hardware Configuration>

<3. DB>

[3-1. User DB]

[3-2. Vendor DB]

[3-3. Merchandise DB]

[3-4. Web Page DB]

[3-5. Review DB]

<4. Example of Each Web Page>

[4-1. Evaluation Posting Page]

[4-2. Merchandise Page]

<5. Process Flow>

[5-1. Overall Flow]

[5-2. Batch Process]

[5-3. First Example of Keyword Extraction Process]

[5-4. Second Example of Keyword Extraction Process]

[5-5. Third Example of Keyword Extraction Process]

[5-6. Fourth Example of Keyword Extraction Process]

[5-7. Fifth Example of Keyword Extraction Process]

[5-8. First Example of Evaluation Word Selection Process]

[5-9. Second Example of Evaluation Word Selection Process]

[5-10. First Example of Evaluation Word Presentation Process]

[5-11. Second Example of Evaluation Word Presentation Process]

<6. Modifications>

[6-1. First Modification]

[6-2. Second Modification]

<7. Summary>

<8. Program and Storage Medium>

### 1. Overall Configuration

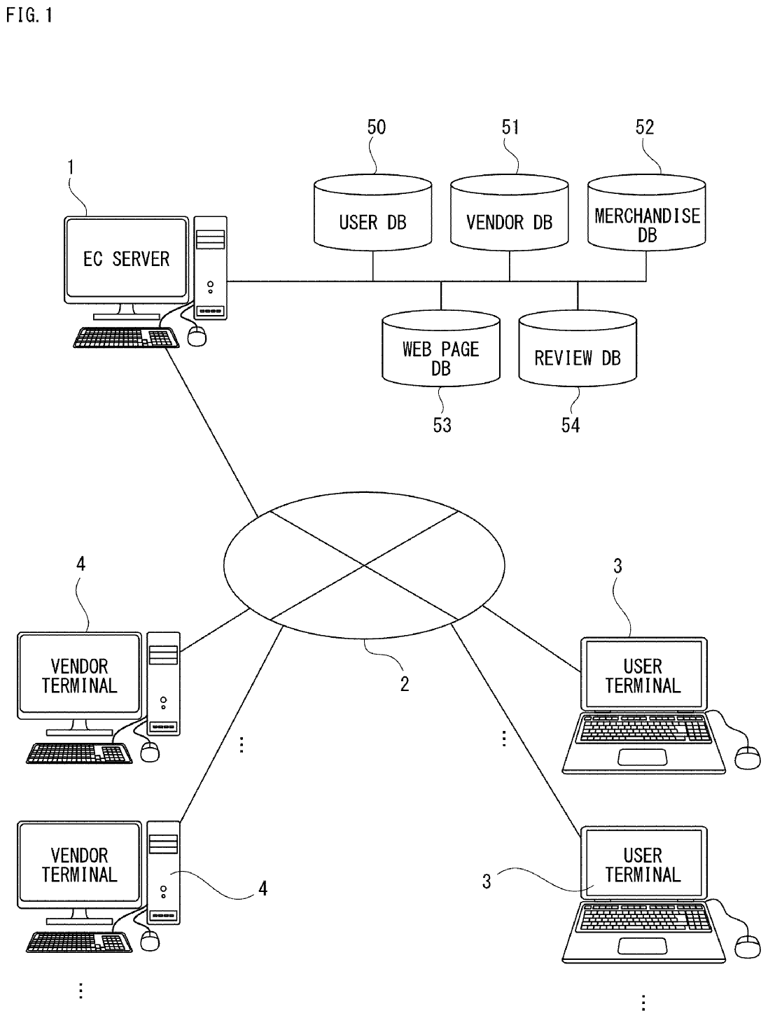

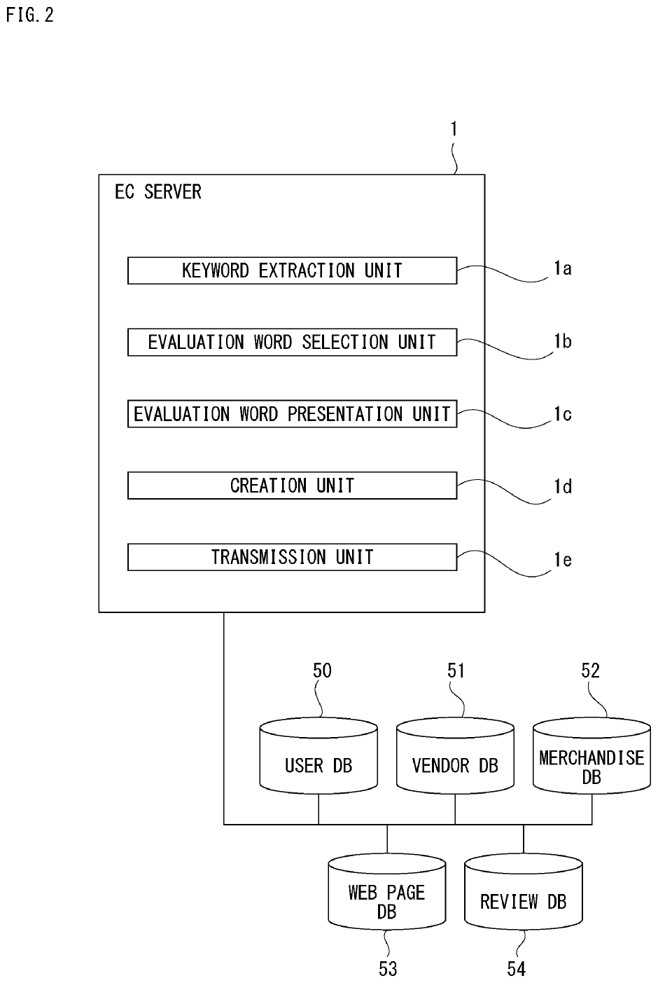

An overall configuration of a network system including an EC server 1 as the embodiment will be described by referring to FIG. 1 and FIG. 2.

As illustrated in FIG. 1, the EC server 1 of the embodiment is coupled to user terminals 3, 3, . . . and vendor terminals 4, 4, . . . via a communication network 2 in a mutually communicative state.

The EC server 1 provides various functions that manage a virtual mall site (EC site) that ensures an electronic commerce using the communication network 2. For example, the EC server 1 provides various functions for a user to purchase a merchandise via the EC site.

Specifically, there are a plurality of shops that participate the electronic commerce operated using the EC server 1. The EC server 1 has a function for administrators (hereinafter described as vendors) of these shops to register information (merchandise information) of the merchandise to be sold and a function to change the registered merchandise information. Therefore, the EC server 1 includes a function that manages participating shop information, vendor information, and the merchandise information.

The EC server 1 also has, for example, a function to search and present a merchandise desired by a user from a group of merchandise handled in the electronic commerce, a function to pass an order of the merchandise to a vendor when the user performs a purchase operation for the merchandise, a settlement process function to mediate a payment exchange when the purchase and sale of the merchandise is determined, a function to deliver the merchandise to each user, and then, a notification function to the user when the purchase of the merchandise is confirmed and a function to notify the vendor of information of the user who has purchased the merchandise.

When the user purchases the merchandise, shipping (address) information for the merchandise and information of a credit card number and a contact address (for example, e-mail address) are required. In order to eliminate a labor hour of inputting such information every time the user purchases the merchandise, the EC server 1 includes a function to manage the user information.

Further, the EC server 1 provides functions regarding a review posted per handling merchandise or per shop.

Specifically, the functions are, for example, a function to accept the review posted by the user and a function to cause other information processing apparatuses to display the posted review.

Then, the EC server 1 creates and transmits web page data in order to cause a web page as a user interface for ensuring the above-described various functions to be displayed on the other information processing apparatuses (the user terminal 3 and the vendor terminal 4).

The EC server 1 also includes, for example, a function to authenticate the user and the vendor, a function to register information in various databases, and a function to acquire the information from the various databases.

In order to ensure the various functions described up to the present, the EC server 1 manages a user Database (DB) 50 that stores the user information, a vendor DB 51 that stores information of the vendor who sells the merchandise, a merchandise DB 52 that stores information of the merchandise handled in the electronic commerce, a web page DB 53 that stores the web page data of various web pages, and a review DB 54 that stores information regarding the review.

A configuration of the communication network 2 is not especially limited. For example, the Internet, an intranet, an extranet, a Local Area Network (LAN), a Community Antenna TeleVision (CATV) communications network, a Virtual Private Network, a telephone network, a mobile communications network, a satellite communications network, or a similar network is assumed.

Various examples are also assumed as transmission medium configuring all or a part of the communication network 2. The transmission medium, for example, can be a wire such as an Institute of Electrical and Electronics Engineers (IEEE) 1394, a Universal Serial Bus (USB), a power-line carrier, and a telephone line; and also a wireless such as infrared light like Infrared Data Association (IrDA), Bluetooth (registered trademark), 802.11 wireless, a mobile telephone network, a satellite channel, and a digital terrestrial broadcasting network.

The user terminal 3 is a terminal used by a user who searches, browses, and purchases the merchandise using the electronic commerce service provided by the EC server 1.

The vendor terminal 4 is a terminal used by a vendor who sells the merchandise using the electronic commerce service provided by the EC server 1.

In the user terminal 3 and the vendor terminal 4, various transmitting/receiving processes and display processes are executed as necessary. The user terminal 3 and the vendor terminal 4 are, for example, Personal Computers (PCs) including a communication function, feature phones, Personal Digital Assistants (PDAs), or smart devices such as smart phones and tablet terminals.

The user terminal 3 and the vendor terminal 4 only take on different names depending on if a person who uses the terminal is a person in a position of purchasing the merchandise or a person in a position of selling the merchandise for explanatory purpose, thus substantially having an identical configuration.

A description will be given of respective distinctive parts of the EC server 1 in the embodiment with reference to FIG. 2.

As described above, the EC server 1 includes the function regarding the review posted per handling merchandise or per shop.

Therefore, the EC server 1 includes a keyword extraction unit 1a, an evaluation word selection unit 1b, and an evaluation word presentation unit 1c.

The keyword extraction unit 1a extracts keywords corresponding to the merchandise category per merchandise category to which each merchandise managed by the EC server 1 belongs.

Although a specific example will be described later, the keyword extraction unit 1a extracts a word or a phrase that appears in a merchandise page and a review text as a keyword.

The evaluation word selection unit 1b executes a process to select an evaluation word to present on an evaluation posting page where the review and the like for the merchandise are posted from the keywords extracted by the keyword extraction unit 1a.

The evaluation word presentation unit 1c executes a process to present the evaluation word in the evaluation posting page. For this process, some examples will be described later.

A creation unit 1d executes a web page data creation process to create web page data to cause a predetermined web page such as a merchandise page, a user page, and the evaluation posting page to be displayed on a web browser operating on the user terminal 3. The evaluation posting page is, for example, a web page where an entry field to input the review text to be posted is provided.

The web page data is, for example, a structured document file such as a Hyper Text Markup Language (HTML) and an Extensible HyperText Markup Language (XHTML). In the structured document file, text data such as a merchandise explanation, image data such as a merchandise image, and their placement and display format (for example, a text color, a font, a size, and a decoration) are described.

A transmission unit 1e executes a web page data transmission process to transmit the prior web page data created by the creation unit 1d to the user terminal 3 that has made a request.

### 2. Hardware Configuration

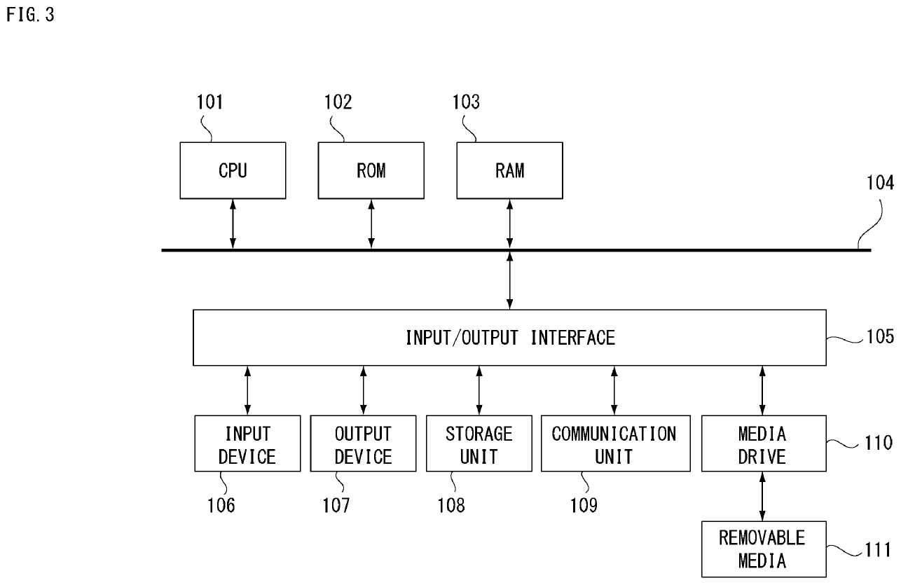

FIG. 3 is a view exemplifying hardware of the EC server 1, the user terminal 3, the vendor terminal 4, and the user DB 50, the vendor DB 51, the merchandise DB 52, the web page DB 53, and the review DB 54 illustrated in FIG. 1. A Central Processing Unit (CPU) 101 of a computer device in each server or terminal executes various processes in accordance with a program stored in a Read Only Memory (ROM) 102 or a program loaded from a storage unit 108 to a Random Access Memory (RAM) 103. The RAM 103 also appropriately stores data required for the CPU 101 to execute various processes or similar data.

The CPU 101, the ROM 102, and the RAM 103 are mutually coupled via a bus 104. An input/output interface 105 is also coupled to this bus 104.

To the input/output interface 105, an input unit 106 including a keyboard, a computer mouse, a touchscreen, or a similar component, a display including a Liquid Crystal Display (LCD), a Cathode Ray Tube (CRT), an organic Electroluminescence (EL) panel, or a similar component, an output unit 107 including a speaker and a similar component, the storage unit 108 including a Hard Disk Drive (HDD), a flash memory device, or a similar component, and a communication unit 109 that executes a communication process and communication between devices via the communication network 2 are coupled.

Additionally, to the input/output interface 105, a media drive 110 is coupled as necessary and a removable media 111, such as a magnetic disk, an optical disk, a magneto-optical disk, or a semiconductor memory is mounted as appropriate in order to write and read information to/from the removable media 111.

Such computer device uploads and downloads data and a program through communications by the communication unit 109. Such computer device also can exchange the data and the program via the removable media 111.

When the CPU 101 executes process operations based on various programs, information processing and communication that are described later are executed in each of the EC server 1, the user terminal 3, the vendor terminal 4, and the user DB 50, the vendor DB 51, the merchandise DB 52, the web page DB 53, and the review DB 54.

Respective information processing apparatuses that constitute the EC server 1, the user terminal 3, the vendor terminal 4, and the user DB 50, the vendor DB 51, the merchandise DB 52, the web page DB 53, and the review DB 54 are not limited to be configured of a computer device as in FIG. 3 alone, and may be configured such that a plurality of computer devices are systemized. The plurality of computer devices may be systemized by the LAN and the like, or may be remotely disposed in a communicative state by a Virtual Private Network (VPN) or the like using the Internet or the like.

### 3. DB

### 3-1. User DB

The user DB 50 stores information of a user who receives a service provided by the EC server 1 as attribute information. For example, the user DB 50 stores personal information such as a login password name, an age, a gender, a yearly income, an address, an e-mail address, and a hobby in association with one user Identification (ID) that can identify one user. The user DB 50 also stores, for example, payment information, a purchase history of the merchandise, and favorite registration information of the merchandise.

### 3-2. Vendor DB

The vendor DB 51 stores information of a vendor who sells the merchandise using the EC server 1. The vendor DB 51 stores, for example, respective information such as a login password, a shop name, a shop logo, a merchandise ID (merchandise unique code information given per merchandise by the EC server 1) of the handling merchandise, a merchandise page Uniform Resource Locator (URL), a price per merchandise, a URL of a vendor page, and a contact address (for example, a telephone number and an e-mail address) in association with a vendor ID that can uniquely identify each vendor.

The merchandise page URL is a URL given per merchandise page. Different merchandise page URLs are given when the vendors are different even if the merchandise is identical.

The shop logo information may be the image data itself, or may be, for example, link information (URL information) of the stored image data.

### 3-3. Merchandise DB

The merchandise DB 52 stores information regarding each merchandise that can be purchased and sold via the EC server 1. For example, the merchandise DB 52 stores a merchandise category, a merchandise image, manufacturer (maker) information, model number information given by the manufacturer, a sales release day, handling merchandise provider information, inventory information, and the like in association with a merchandise ID that can uniquely identify a merchandise.

The merchandise image information may be the image data itself, or may be link information (for example, URL information) of the stored image data.

The merchandise DB 52 may also store, for example, a place of production and a specification of the merchandise (the color, the size, and performance information) other than those above.

### 3-4. Web Page DB

The web page DB 53 stores data of various web pages provided to the user and the vendor by the EC server 1. Specifically, the data is the web page data such as the merchandise page, a merchandise detail page, or the user page and the vendor page, and a shop page.

Uniform Resource Locator (URL) information of the web page and information of a placement and a display format (for example, a position, the size, and the color) for an object (for example, an image, a text, and a banner) arranged on each web page are stored as the web page data.

The information stored in the web page DB 53 may be stored as the structured document file such as the HTML.

### 3-5. Review DB

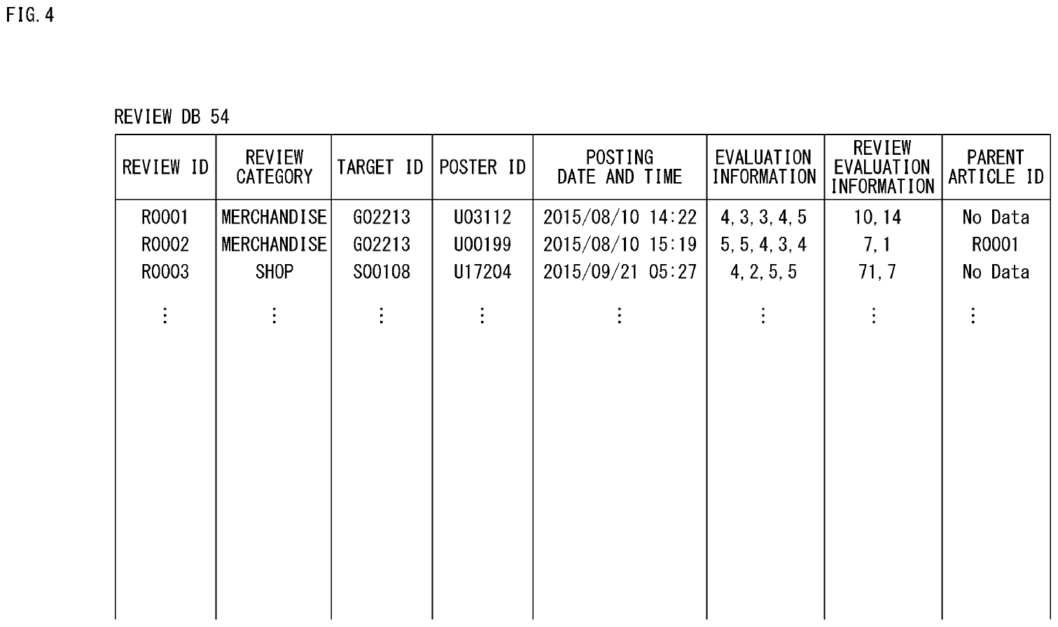

As illustrated in FIG. 4, the review DB 54 stores the information regarding the review posted by the user. For example, the review DB 54 stores a review category indicating which one is a review target: the merchandise and the shop, a review target ID (for example, the merchandise ID and the shop ID), the user ID of a poster, posting date and time information, merchandise (or shop) evaluation information, review evaluation information, a parent article ID indicating presence/absence of another review text as a parent review, and the like in association with a review ID that can uniquely identify the review.

In the embodiment, the review sometimes includes the review text in addition to the evaluation information for the merchandise. In such a case, although not illustrated in FIG. 4, the review text is stored in association with the review ID.

The merchandise evaluation information is evaluation information for the merchandise.

Another user can evaluate the review text posted by a certain user. For example, the web page to browse the review includes an agreement button that the user can indicate an agreement to a review content and a disagreement button that the user can indicate a disagreement to the review content. The content of the review text is evaluated depending on the numbers that these buttons are pressed. The review evaluation information is evaluation information for such a content of the review text.

The parent article ID is information representing whether this review text is a reply to another review text. When this review text is a reply taking the other review text as its parent, a review ID of the parent review text is stored.

Specifically, a description will be given using some records illustrated in FIG. 4.

A review whose review ID is R0001 is posted for a merchandise whose merchandise ID is “G02213.” The user ID of a poster is “U03112.” The posting date and time is “14:22 on 10 Aug. 2015.” The evaluation information is “4, 3, 3, 4, 5.” The first “4” indicates a comprehensive evaluation value (five-level), and the remaining “3, 3, 4, 5” indicate four individual evaluation values (five-level). That is, this merchandise is evaluated in the one comprehensive evaluation value and the four individual evaluation items. This review includes the review text that the merchandise is evaluated by the text. Information that another user has evaluated this review text is stored as the review evaluation information. The number of users who approve of the content of the review text is “10,” and the number of users who disapprove of the content of the review text is “14.”

A review whose review ID is R0002 is posted for the merchandise whose merchandise ID is “G02213” similarly to the prior review. Further, this review is a review posted for the prior review text, thus having a parent article ID that is “R0001.”

Further, the review DB 54 also stores a review such as R0003 whose review category is “Shop.”

### 4. Example of Each Web Page

### 4-1. Evaluation Posting Page

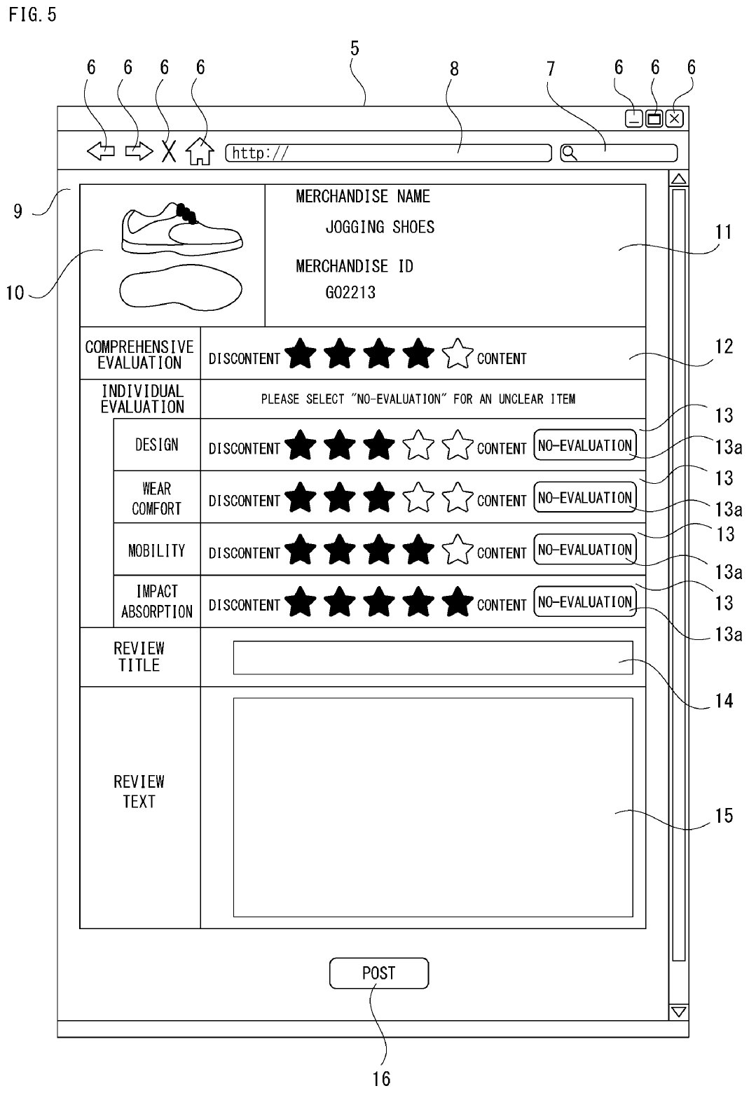

As one example of the evaluation posting page, FIG. 5 illustrates a web page when a review article for the merchandise is posted.

Various operators 6, 6, 6, . . . to change the web page and the display format are located in the proximity of an upper end part of a web browser 5 installed in the user terminal 4. A search form 7 to search the web page and an address display part 8 to display the Uniform Resource Locator (URL) of the displayed web page are also located.

Further, a web page display part 9 to display the web page is located below them.

FIG. 5 illustrates a state where the evaluation posting page to post the review for the merchandise is displayed in the web page display part 9.

Specifically, a merchandise image display area 10 to display a merchandise image of the merchandise as a review target, a merchandise name display area 11 to display the merchandise name and the merchandise ID, a comprehensive evaluation column 12 to input an overall evaluation value for the merchandise, individual evaluation columns 13, 13, 13, . . . to input evaluation values of the individual evaluation items set per merchandise (or per merchandise category), a review title entry field 14 to input a title sentence of the review, a review text entry field 15 to input the review text, and a posting button 16 to post the content of the input review are each located.

For each individual evaluation column 13, a no-evaluation button 13a selected when the evaluation for the evaluation item is not performed is provided. This button is located so that the user can press it when the evaluation item is not appropriate and the evaluation is impossible for the merchandise.

For the comprehensive evaluation column 12 and the individual evaluation columns 13, 13, 13, . . . , respective five stars are displayed, thus ensuring one to five five-level evaluation. In the drawing, the comprehensive evaluation value is “4,” and the individual evaluation values are “3,” “3,” “4,” and “5” from top to bottom.

### 4-2. Merchandise Page

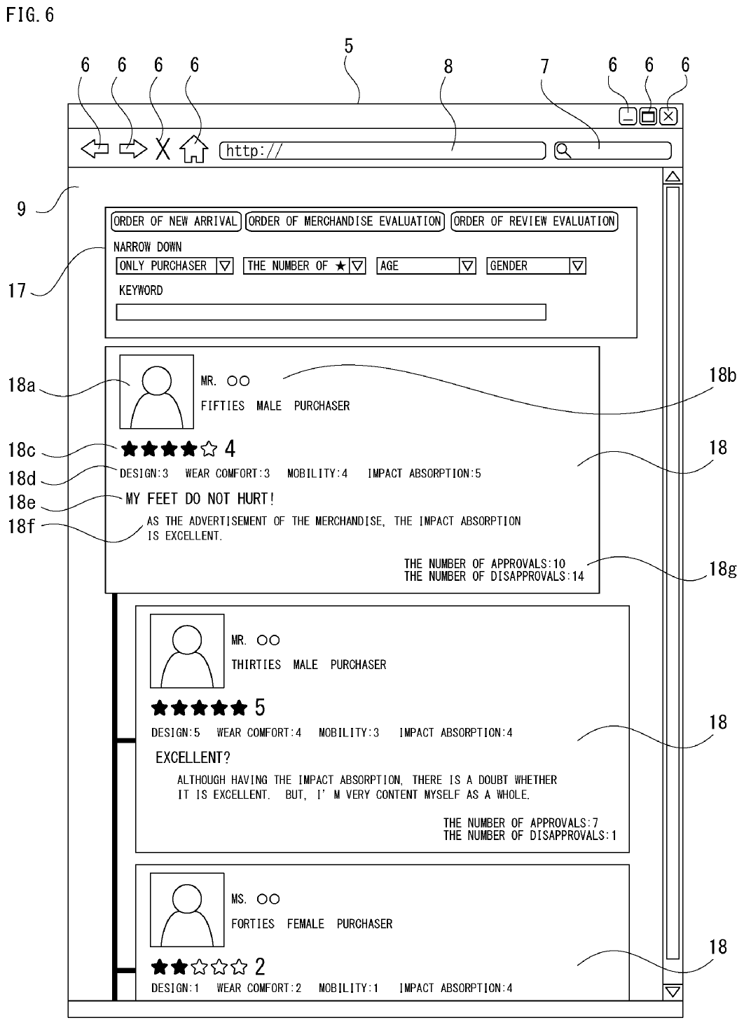

FIG. 6 illustrates a state where the review content in the merchandise page where the detail information and the review content for the merchandise are displayed is displayed on the web browser 5.

A narrowing-down criteria entry field 17 to narrow down the reviews and reviews 18, 18, 18, . . . are displayed in tandem in the web page display part 9 on the browser 5.

In the review 18, a user image display area 18a to display a user image, a user information display column 18b to display the user information, and the review content are displayed.

As the review content, a comprehensive evaluation display column 18c to display the comprehensive evaluation value, an individual evaluation display column 18d to display the individual evaluation value, a review title display column 18e to display the review title, and a review text display column 18f to display the review text are located.

In the review 18, an agreement number display column 18g to display the number of users who have agreed with the review and the number of users who have disagreed with the review is located.

Three reviews 18, 18, and 18 illustrated in FIG. 6 represent a state where two reviews are posted in a reply form with respect to one review.

### 5. Process Flow

### 5-1. Overall Floyd

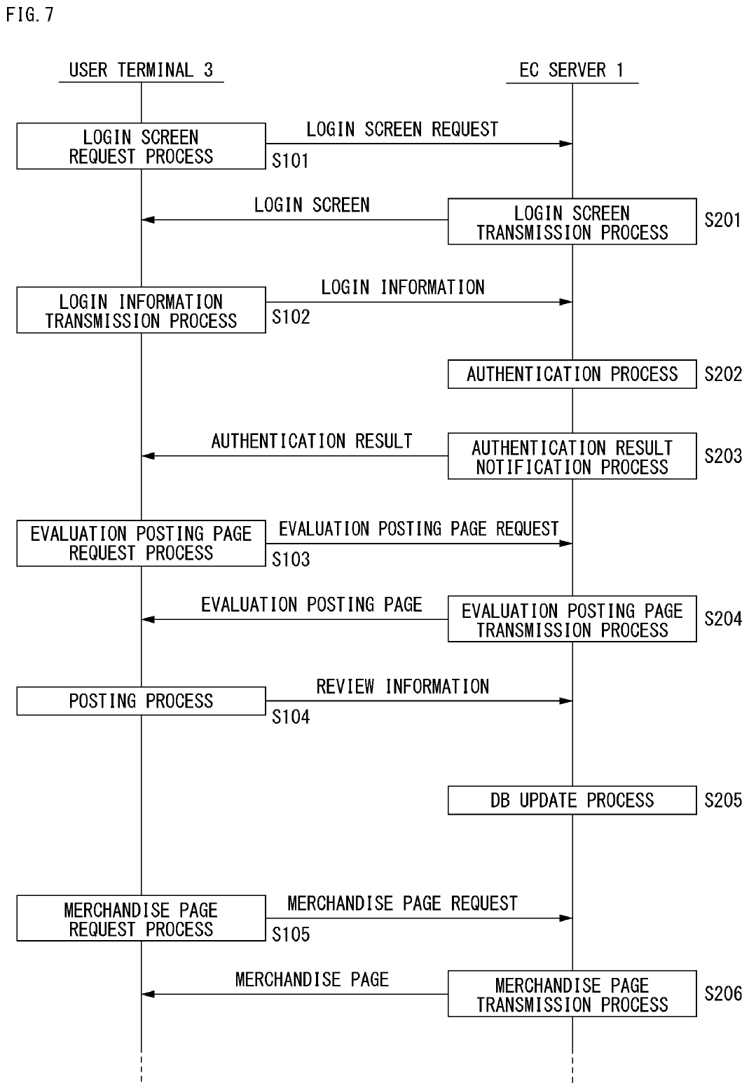

One example of an overall flow of the process in the embodiment will be shown with reference to FIG. 7.

The user terminal 3 executes a login screen request process corresponding to a login screen display operation by the user in Step S101. After the login screen request process transmits a login screen request from the user terminal 3 to the EC server 1, the EC server 1 executes a login screen transmission process in Step S201.

Corresponding to the web page data received from the EC server 1, a login screen of an EC site is displayed on the user terminal 3.

Next, the user terminal 3 executes a login information transmission process that transmits login information corresponding to an input operation of login information (the user ID and the password) by the user to the EC server 1 in Step S102. After the login information is transmitted from the user terminal 3 to the EC server 1, the EC server 1 executes an authentication process in Step S202, and then, executes an authentication result notification process in subsequent Step S203.

Specifically, the EC server 1 compares the user ID and the password input on the user terminal 3 with the information stored in the user DB 50 to determine whether the user may login or not, thus notifying the user terminal 3 of an authentication result. Web page data of a front page of the EC site may be transmitted along with returning the authentication result to the user terminal 3. This performs the user authentication and displays the front page of the EC site on the user terminal 3.

The sequential flow illustrated in FIG. 7 shows a case where a determination that the login is permitted is performed in the authentication process in Step S202. When a determination that the login is not permitted is performed in Step S202, the user terminal 3 executes the process in Step S102 again. Corresponding to this, the EC server 1 executes the process in Step S202.

Subsequently, the user terminal 3 executes a process to request an evaluation posting page corresponding to the user operation in Step S103. This transmits an evaluation posting page request from the user terminal 3 to the EC server 1.

The EC server 1 that has received the evaluation posting page request executes a process to transmit the information of the evaluation posting page in Step S204.

Reception of this information by the user terminal 3 displays the evaluation posting page as illustrated in FIG. 5 on the screen of the user terminal 3.

After the user performs various input in the evaluation posting page and then, presses the posting button 16 illustrated in FIG. 5, the user terminal 3 executes a posting process. This process transmits the review information input by the user to the EC server 1.

The EC server 1 that has received the review information executes a process to update the review DB 54 in Step S205. This process accumulates the review information in the review DB 54.

Subsequently, corresponding to the operation by the user to browse the web page where the review in the merchandise page is included, the user terminal 3 executes a process to request the information of the merchandise page. This transmits a merchandise page request from the user terminal 3 to the EC server 1.

The EC server 1 that has received the merchandise page request from the user terminal 3 executes a process to transmit the information (the web page data) of the merchandise page in Step S206.

Reception of this information by the user terminal 3 displays the web page as illustrated in FIG. 6 on the screen of the user terminal 3.

Execution of each process illustrated in FIG. 7 by the user terminal 3 and the EC server 1 displays the evaluation word in the evaluation posting page. In the example in FIG. 5, the evaluation word is presented as the individual evaluation item. For this, the evaluation word preferably has been set before the reception of the evaluation posting page request illustrated in Step S103 in FIG. 7. In the following description, a process until the evaluation word is set will be mainly described.

For how the evaluation word is presented, some examples will be described later.

### 5-2. Batch Process

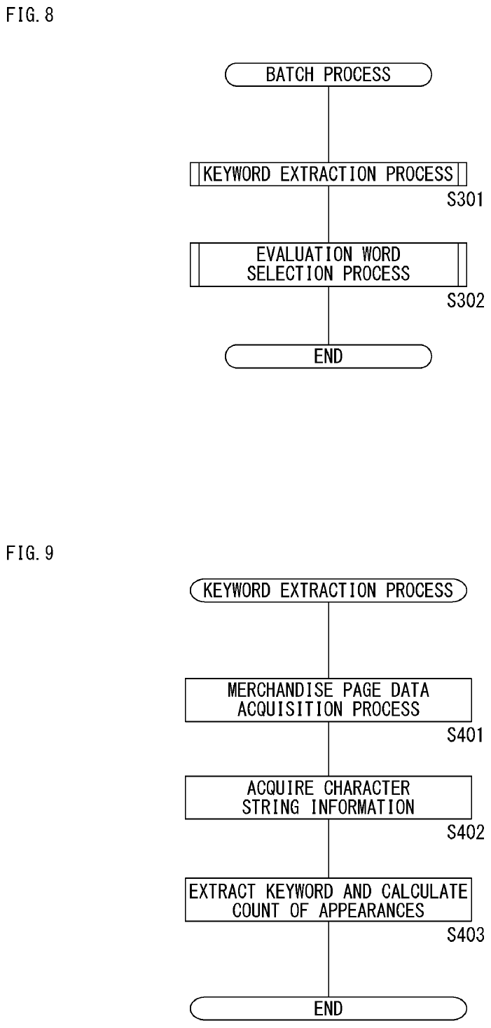

With reference to FIG. 8, a description will be given of an example where the process until the evaluation word is set is periodically executed by a batch process.

The batch process is executed per merchandise category. The merchandise category may include, for example, various subcategories such as “Home Appliance.” The merchandise category may be a merchandise category per sub category such as “Cleaner” and “Washing Machine,” or may be a section such as “Cleaner of XX Company” including, for example, a manufacturer name. Further, the merchandise category may be finer per merchandise (product).

After the batch process starts, a sequence of processes illustrated in FIG. 8 are executed.

That is, first, the EC server 1 executes a keyword extraction process that extracts keywords as candidates for the evaluation words from various information managed by the EC server 1 in Step S301.

Concrete examples of the keyword extraction process will be described later.

Subsequently, the EC server 1 executes a process to select the evaluation word from the keywords extracted in the prior keyword extraction process in Step S302. This process presents the evaluation word in the evaluation posting page displayed on, for example, the screen of the user terminal 3.

Concrete examples of the evaluation word selection process will be described later.

Thus, the execution of the batch process per merchandise category selects the keyword corresponding to the merchandise category as the evaluation word. That is, it is also possible to select a specific keyword reflecting a feature per merchandise category as the evaluation word.

### 5-3. First Example of Keyword Extraction Process

A first example of the keyword extraction process will be described with reference to FIG. 9.

In the first example of the keyword extraction process, words and phrases that frequently appear in the merchandise page are extracted as the keywords.

The EC server 1 first executes a process to acquire merchandise page data in Step S401.

In the merchandise page data acquisition process, the web page data (for example, HTML) of the merchandise page is acquired.

Subsequently, the EC server 1 executes a process to acquire character string information included in the web page data in Step S402. This process extracts character string (word and text) information that has omitted image data and the like from the web page data.

Subsequently, the EC server 1 extracts the keyword from the character string information and counts the count of appearances in Step S403. The keyword extracted here is, for example, a noun. The counting of the count of appearances per keyword ensures calculation of an appearance frequency of the keyword. The count of appearances is associated with the keyword to be used in an evaluation word selection process described later.

### 5-4. Second Example of Keyword Extraction Process

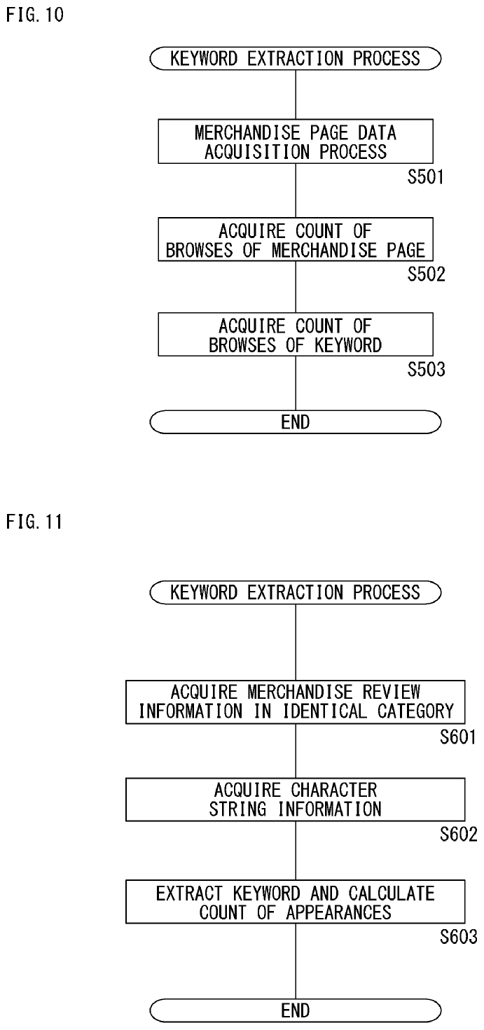

A second example of the keyword extraction process will be described with reference to FIG. 10.

In the second example of the keyword extraction process, the keyword is extracted corresponding to the count of appearances of the keyword, considering the count of browses of the merchandise page.

The EC server 1 first executes the merchandise page data acquisition process in Step S501.

Subsequently, the EC server 1 acquires the count of browses per merchandise page in Step S502. Here, the EC server 1, for example, acquires the count of browses in the last one month. The EC server 1 may acquire the count of browses over an entire period without determining a period.

Next, the EC server 1 calculates the count of appearances considering the count of browses of the merchandise page (that is, the count of browses of the keyword) in Step S503.

The count of browses of the keyword is associated with the keyword to be used in the evaluation word selection process described later.

### 5-5. Third Example of Keyword Extraction Process

A third example of the keyword extraction process will be described with reference to FIG. 11.

In the third example of the keyword extraction process, the keyword is extracted from the review text for the merchandise.

The EC server 1 first acquires the review information posted for the merchandise categorized into the merchandise category as a keyword extraction target in Step S601.

Subsequently, the EC server 1 executes a process to acquire the character string information from the review information in Step S602.

Lastly, the EC server 1 executes a process to extract the keyword from the character string information and counts the count of appearances in Step S603. The count of appearances is associated with the keyword to be used in the evaluation word selection process described later.

### 5-6. Fourth Example of Keyword Extraction Process

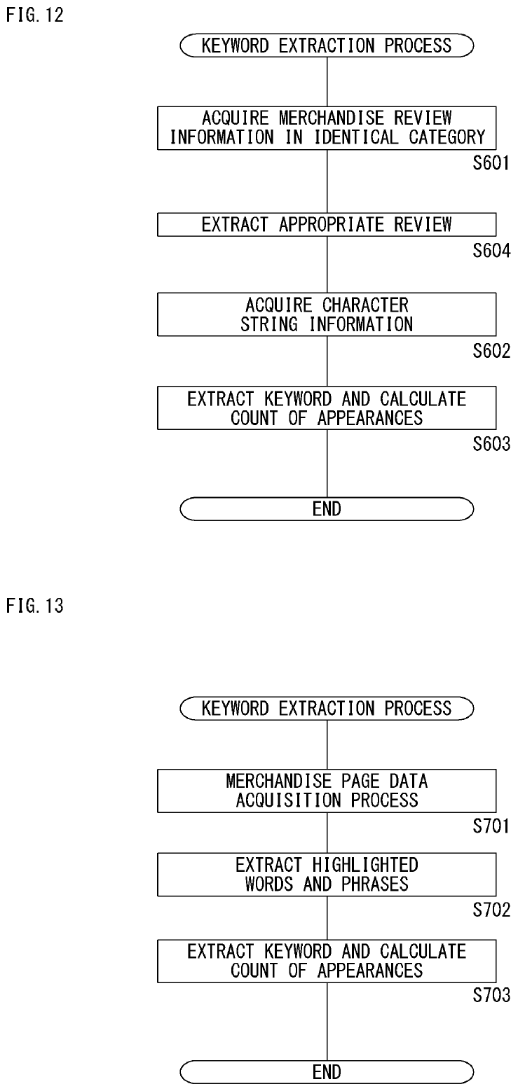

A fourth example of the keyword extraction process will be described with reference to FIG. 12.

In the fourth example of the keyword extraction process, the keyword extraction is executed considering whether the review text for the merchandise is appropriate.

Specifically, the EC server 1 acquires the review information posted for the merchandise categorized into the merchandise category as the keyword extraction target in Step S601. This process is a process similar to the process in Step S601 in the prior third example of the keyword extraction process.

Subsequently, the EC server 1 executes a process to extract an appropriate review in Step S604. This process extracts only appropriate review information from the acquired review information.

The determination whether the review is appropriate or not is made, for example, depending on the evaluation made by other users for the review. For example, as illustrated in FIG. 4, the number of users who have approved of the content of the review text (the number of approvals) and the number of users who have disapproved of the content of the review text (the number of disapprovals) are associated with the review DB 54. Based on this numerical value, a review whose number of users who have approved of the content of the review text is large is determined to be appropriate. A review whose numerical value that the number of disapprovals is subtracted from the number of approvals is large may be determined to be appropriate. Alternatively, a review whose proportion of the number of approvals to the number of disapprovals is high may be determined to be appropriate.

As another example to determine whether the review is appropriate or not, an analysis of the review content using the natural language process may be executed. For example, a too short text may be determined to be inappropriate, or a text that is long and includes a certain number of or more negative words and positive words may be determined to be appropriate. For such a technique, there is much prior art, thus omitting the detailed description.

Subsequently, the EC server 1 acquires the character string information from the review information determined as an appropriate review in Step S602, extracts the keyword and counts the count of appearances in Step S603. These processes are similar to the processes described in the third example of the keyword extraction process.

The count of appearances is associated with the keyword to be used in the evaluation word selection process described later.

### 5-7. Fifth Example of Keyword Extraction Process

A fifth example of the keyword extraction process will be described with reference to FIG. 13.

In the fifth example of the keyword extraction process, the keyword is extracted from a character string highlighted in the merchandise page.

Specifically, the EC server 1 executes a merchandise page data acquisition process in Step S701. This process is similar to the process in Step S401 in FIG. 9.

Subsequently, the EC server 1 executes a process to extract the highlighted character string information from the character string information included in the web page data in Step S702. This process extracts the highlighted character string from the web page data.

The highlighted character string is, for example, a character string whose character size is made larger than that of other characters, a character string displayed in a striking text color such as red, or a character string displayed in a font different from others.

Next, the EC server 1 further extracts a character string as the keyword from the extracted character strings and counts the count of appearances in Step S703. The count of appearances is associated with the keyword to be used in the evaluation word selection process described later.

### 5-8. First Example of Evaluation Word Selection Process

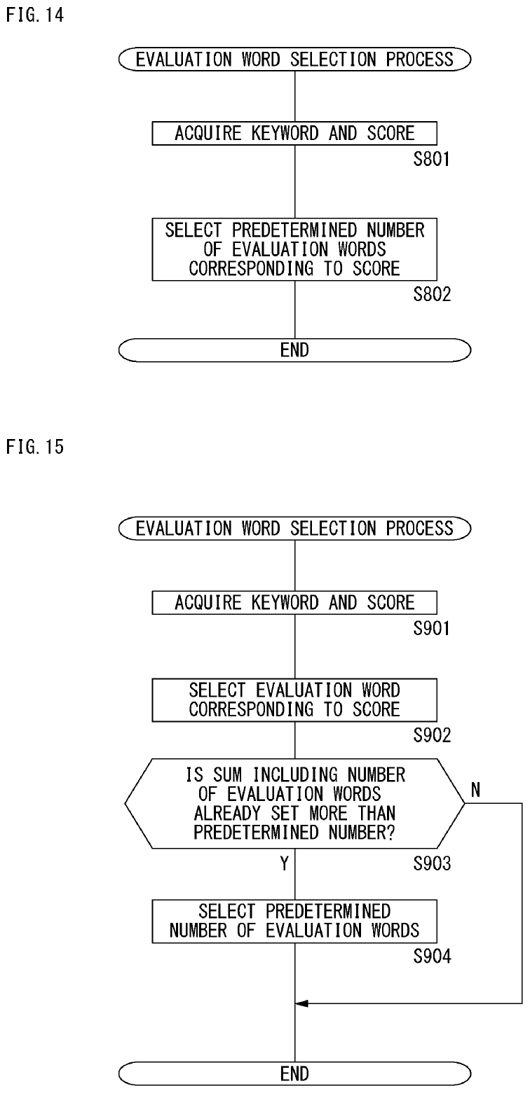

A first example of the evaluation word selection process will be described with reference to FIG. 14.

In the first example of the evaluation word selection process, the evaluation word is selected corresponding to a score (the count of appearances and the count of browses) associated with the keyword in each prior example of the keyword extraction process.

Specifically, the EC server 1 executes a process to acquire the keyword and the score in Step S801.

Subsequently, the EC server 1 executes a process to select the evaluation word corresponding to the score in Step S802.

This selects, for example, the evaluation word corresponding to the count of appearances. When the evaluation word selection process is executed after the second example of the keyword extraction process, the evaluation word is selected corresponding to the count of browses.

In Step S802, a predetermined number of evaluation words may be selected. The selection by the predetermined number does not present a large amount of evaluation words to the user, and presents an adequate number of evaluation words for writing the review.

### 5-9. Second Example of Evaluation Word Selection Process

A second example of the evaluation word selection process will be described with reference to FIG. 15.

In the second example of the evaluation word selection process, a replacement process of the evaluation words is executed in order to keep the number of the evaluation words at the predetermined number.

Specifically, the EC server 1 executes a process to acquire the keyword and the score in Step S901.

Subsequently, the EC server 1 executes a process to select the evaluation word corresponding to the score in Step S902.

At this point of time, there are the evaluation words (for example, three pieces) that are additionally selected this time and the evaluation words (for example, four pieces) that have been already selected.

Subsequently, the EC server 1 determines whether the sum of the evaluation words (for example, three pieces) additionally selected this time and the evaluation words (for example, four pieces) already selected is equal to or more than a predetermined number (for example, five pieces) or not in Step S903. When the EC server 1 determines that the sum is equal to or less than the predetermined number, the EC server 1 terminates the sequence of processes illustrated in FIG. 15.

On the other hand, as exemplified, when the EC server 1 determines that the sum is equal to or more than the predetermined number (3+4=7 pieces>5 pieces), the EC server 1 executes a process to select the predetermined number of evaluation words from these evaluation words in Step S904.

For example, the EC server 1 selects the predetermined number of, that is, five pieces of evaluation words by taking two pieces whose scores are high this time from the existing four pieces of evaluation words and adding three pieces of evaluation words additionally selected.

### 5-10. First Example of Evaluation Word Presentation Process

One way to present the evaluation word to the user will be described by referring to the evaluation posting page illustrated in FIG. 5.

The keywords selected as the evaluation words are displayed as evaluation item names (“Design,” “Wear Comfort,” “Mobility” and “Impact Absorption” in FIG. 5) in the individual evaluation columns 13 in FIG. 5.

That is, the user who evaluates the merchandise is prompted to make an evaluation per evaluation word.

In the prior second example of the evaluation word selection process described in FIG. 15, the example of the evaluation word replacement process has been described.

In this example, the replacement of the evaluation words is identical to a replacement of the individual evaluation items.

Therefore, at the time of the evaluation word replacement process, an individual evaluation item whose number that the no-evaluation button 13a in FIG. 5 is pressed is large may be preferentially removed from options. This can eliminate the individual evaluation item or the like that is difficult to evaluate.

### 5-11. Second Example of Evaluation Word Presentation Process

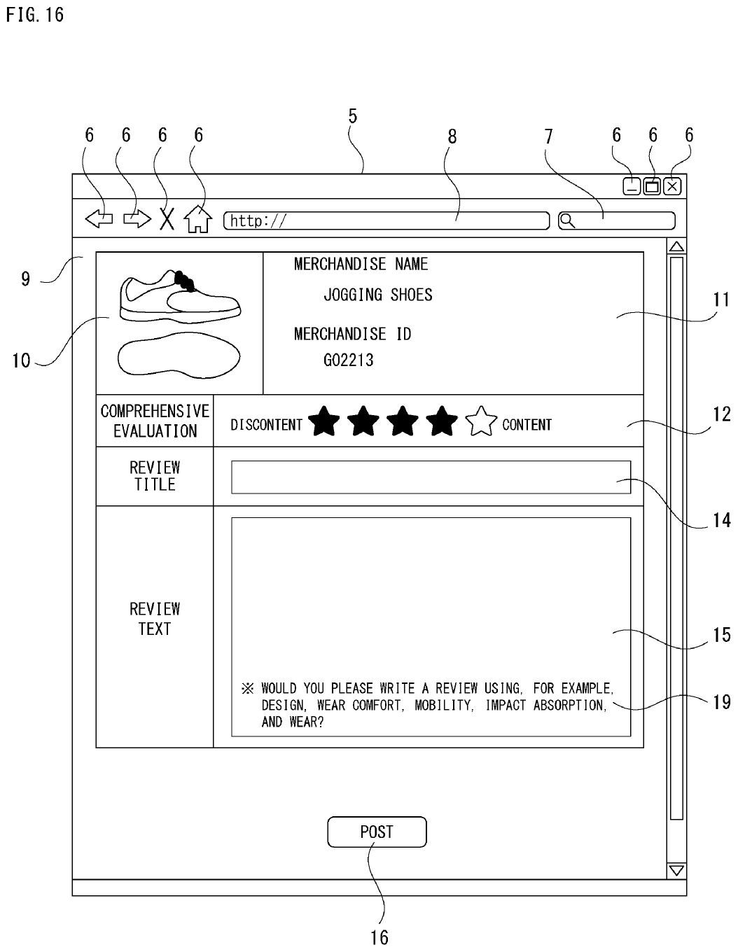

For another example of a way to present the evaluation word to the user, the other example will be described with reference to an evaluation posting page illustrated in FIG. 16.

In this example, the keywords that seem to be applicable to the evaluation are presented as suggested words to facilitate the review for the merchandise by the user.

Specifically, as illustrated in FIG. 16, a suggested word presentation sentence 19 that presents the suggested words is displayed in a lower part of the review text entry field 15.

In prior Step S403 in FIG. 9, the example to extract the noun from the character string data as the keyword has been described. However, in this example to present the evaluation word as an aid in the text input, the presented evaluation word is not necessarily the noun. Therefore, in Step S403, verbs and adjectives may be extracted as the keywords.

The evaluation posting page illustrated in FIG. 16 may be configured including the individual evaluation column 13 in FIG. 5. In this case, for the evaluation item name in the individual evaluation column 13 and the suggested word, different keywords may be used. This can promote the review from various aspects.

### 6. Modification

### 6-1. First Modification

In the third example of the keyword extraction process, in Step S603, the example to execute the process to extract the keyword from the character string information and count the count of appearances has been described.

As a modification for this, the count of browses of the review information may be added. Specifically, the count of browses of the keyword (one that multiplies the count of browses of the review information by the count of appearances) is calculated per review. By adding them, the count of browses of the keyword for the whole reviews as the target is calculated.

This can estimate the number that the users substantially see the keyword. Accordingly, the evaluation word that reflects a trend can be presented.

### 6-2. Second Modification

As the evaluation item name of the individual evaluation column 13 illustrated in FIG. 5, the example to display the keyword selected by the above-described keyword extraction process and evaluation word selection process has been describe. However, in preparation for a case where there is no appropriate keyword, a default evaluation item name may be preliminarily set.

In this case, the default evaluation item name is replaced each time a keyword suitable for the evaluation item name is selected by the above-described respective processes.

This ensures a minimum number of individual evaluation terms.

### 6-3. Third Modification

In the above, the description has been given taking the review for the merchandise as the target. However, a review for the shop may be the target. For example, when a certain shop is a shop that sells only the merchandise belonging to a certain merchandise category, an evaluation word selected from keywords corresponding to this merchandise category is presented in an evaluation posting page regarding the shop.

This facilitates posting of the review corresponding to the merchandise category as the shop review.

Accordingly, information specialized in the merchandise category that the user wants to know can be presented to the user as the review.

### 7. Summary

As described up to the present, the EC server 1 in the embodiment includes the keyword extraction unit 1a that extracts the keywords corresponding to the merchandise category from the information managed per merchandise category in the electronic commerce site, the evaluation word selection unit 1b that selects the keyword to present in the evaluation posting page for posting the evaluation for the merchandise belonging to the merchandise category from the keywords as the evaluation word, and the evaluation word presentation unit 1c that presents the evaluation word in the evaluation posting page.

This presents the evaluation word using the keyword corresponding to the merchandise category to the user.

Accordingly, the evaluation word presented to the user can be dynamically changed corresponding to the characteristics per merchandise category. That is, it is possible to provide an environment where the posting is performed so that an evaluation content changes corresponding to the merchandise category (for example, suitable for an evaluation item specific to the merchandise category).

Further, a resource of the user terminal 3 can be effectively utilized such that an appropriate evaluation word is presented to the user in a limited presentation area (for example, a monitor) in the user terminal 3 used by the user.

As described in the first example of the evaluation word presentation process, the evaluation word presentation unit 1c presents the evaluation word as the evaluation item name.

This presents the evaluation items including an evaluation item associated with the keyword to the user.

Accordingly, this allows the user to make an evaluation based on the selected evaluation word.

As described in the second example of the evaluation word presentation process, the evaluation word presentation unit 1c presents the evaluation word as the suggested word to assist the input of the review text.

This presents the keyword corresponding to the merchandise category when the review text is input.

Accordingly, the content of the review text can be enhanced, and a load of the user can be reduced at the time of the input of the review by providing an awareness regarding the input content of the review text.

As described in the first example of the keyword extraction process, the keyword extraction unit 1a extracts the keyword from the merchandise page where the information of the merchandise is included.

The information that the user wants to know is likely to be included in the merchandise page. At the time of the merchandise review, the evaluation word based on the information that the user wants to know is presented.

Accordingly, this allows the user to make an evaluation based on the information that the user wants to know.

As described in the fifth example of the keyword extraction process, the keyword extraction unit 1a extracts the character string highlighted in the merchandise page as the keyword.

An important keyword that a merchandise vendor who sells the merchandise wants to mainly assert is often highlighted. Such a keyword is presented as the evaluation word to the user.

This allows the user to make an evaluation that suppresses the point of assertion of the merchandise to evaluate the merchandise.

As described in the third example of the keyword extraction process, the keyword extraction unit 1a extracts the keyword from the review text posted by the user per merchandise category.

The posted review text is likely to include information that a user who is examining a purchase of another merchandise belonging to an identical merchandise category also wants to know. Thus, the keyword extracted from the information that the user who is examining the purchase of the merchandise in the identical merchandise category wants to know is presented as the evaluation word to the user. The review made based on these evaluation words can be an evaluation index that the user wants to know.

Accordingly, this allows the user to make an appropriate evaluation based on the information that the user wants to know.

As described in the fourth example of the keyword extraction process, the keyword extraction unit 1a extracts the keyword from the review text whose content is determined to be appropriate among the review texts.

The appropriate review is likely to include an appropriate keyword. That is, the appropriate keyword is likely to be presented to the user.

This can lead the user to make an appropriate evaluation.

As described in the second example of the keyword extraction process, the evaluation word selection unit 1b selects the evaluation word from the keywords, considering the latest count of browses per unit time of the web page from which the keyword is acquired.

This facilitates a presentation of a keyword reflecting a trend corresponding to the merchandise category to the user.

Accordingly, this can lead the user to make an evaluation including the information that the other user wants to know.

As described in the second example of the evaluation word selection process, when the evaluation word selection unit 1b additionally selects the evaluation word from the keywords, if the number of the keywords already selected as the evaluation word has reached the predetermined number, the evaluation word selection unit 1b replaces the current evaluation word with the keyword additionally selected as the evaluation word to keep the number of the evaluation words at the predetermined number or less.

That is, the number of the evaluation words becomes the predetermined number or less, thus keeping the number of the evaluation items at the predetermined number or less.

This can prevent an increase in the load of the user due to an excess of the number of evaluation items.

### 8. Program and Storage Medium

As described above, the EC server 1 of the present invention has been described. A program in the embodiment is a program to cause a processor (for example, CPU) to execute the processes in the EC server 1.

The program in the embodiment causes the processor to execute a keyword extraction procedure that extracts the keywords corresponding to the merchandise category from the information managed per merchandise category in the virtual mall site.

The program also causes the processor to execute an evaluation word selection procedure that selects the keyword to present in the evaluation posting page for the merchandise belonging to the merchandise category from the keywords as the evaluation word.

Further, the program causes the processing unit to execute an evaluation word presentation procedure that presents the evaluation word in the evaluation posting page.

That is, this program is a program that causes the processing unit to execute the respective processes in Step S201 to Step S206 described in FIG. 7 and the respective processes described in FIG. 8 to FIG. 15.

Such a program ensures the above-described EC server 1.

Then, such a program can be preliminarily stored in an HDD as a storage medium incorporated in equipment such as a computer device, a ROM in a microcomputer including a CPU, and the like. Alternatively, such a program can be temporarily or permanently saved (stored) in a removable storage medium such as a semiconductor memory, a memory card, an optical disk, a magneto-optical disk, and a magnetic disk. Such a removable storage medium can be provided as what is called package software.

Such a program can be installed into a personal computer and the like from the removable storage medium, and can be downloaded from a download website via a network such as a LAN and the Internet.

### DESCRIPTION OF REFERENCE SIGNS

1 EC server, 1a keyword extraction unit, 1b evaluation word selection unit, 1c evaluation word presentation unit, 1d creation unit, 1e transmission unit, 2 communication network, 3 user terminal, 4 vendor terminal, 50 user DB, 51 vendor DB, 52 merchandise DB, 53 web page DB, 54 review DB

1. An information processing apparatus comprising:
at least one processor; and
at least one memory device that stores instructions for a computer, which when executed by the processor, cause the processor to:
extract at least one keyword corresponding to a merchandise category from information managed per merchandise category in an electronic commerce site;
select a keyword to present in an evaluation posting page for posting an evaluation for a merchandise belonging to the merchandise category from the at least one keyword as an evaluation word; and
present the evaluation word in the evaluation posting page,
wherein the processor presents the evaluation word as an individual evaluation item name of an individual evaluation column for a user evaluating the merchandise to input an evaluation value per individual evaluation item set per merchandise or per merchandise category.

2. (canceled)

3. The information processing apparatus according to claim 1, wherein,
in the presentation of the evaluation word, the processor further presents the evaluation word as a suggested word to assist an input of a review text.

4. The information processing apparatus according to claim 1, wherein,
in the extraction of the at least one keyword, the processor extracts the at least one keyword from a merchandise page where merchandise information is included.

5. The information processing apparatus according to claim 4, wherein,
in the extraction of the at least one keyword, the processor extracts a character string highlighted in the merchandise page as the at least one keyword.

6. The information processing apparatus according to claim 1, wherein,
in the extraction of the at least one keyword, the processor extracts the at least one keyword from review texts posted by users per merchandise category.

7. The information processing apparatus according to claim 6, wherein
in the extraction of the at least one keyword, the processor extracts the at least one keyword from a review text whose content is determined to be appropriate among the review texts.

8. The information processing apparatus according to claim 1, wherein,
in the selection of the evaluation word, the processor selects the evaluation word from the at least one keyword, considering a latest count of browses per unit time of a web page from which the keywords are acquired.

9. The information processing apparatus according to claim 1, wherein,
in the selection of the evaluation word, when the evaluation word is additionally selected from the at least one keyword, in a case where a count of the keyword already selected as the evaluation word has reached a predetermined number, the processor replaces the current evaluation word with the keyword additionally selected as the evaluation word to keep a count of the evaluation word at the predetermined number or less.

10. An information processing method that causes an information processing apparatus to execute:
a keyword extracting step of extracting at least one keyword corresponding to a merchandise category from information managed per merchandise category in an electronic commerce site;
an evaluation word selecting step of selecting a keyword to present in an evaluation posting page for a merchandise belonging to the merchandise category from the at least one keyword as an evaluation word; and
an evaluation word presenting step of presenting the evaluation word in the evaluation posting page,
wherein the evaluation word presentation step presents the evaluation word as an individual evaluation item name of an individual evaluation column for a user evaluating the merchandise to input an evaluation value per each individual evaluation item set per merchandise or per merchandise category.

11. (canceled)

12. A non-transitory storage medium that stores a program that causes a processing unit to execute:
a keyword extraction procedure that extracts at least one keyword corresponding to a merchandise category from information managed per merchandise category in an electronic commerce site;
an evaluation word selection procedure that selects a keyword to present in an evaluation posting page for a merchandise belonging to the merchandise category from the at least one keyword as an evaluation word; and
an evaluation word presentation procedure that presents the evaluation word as in the evaluation posting page,
wherein the evaluation word presentation procedure presents the evaluation word as an individual evaluation item name of an individual evaluation column for a user evaluating the merchandise to input an evaluation value per individual evaluation item set per merchandise or per merchandise category.
